(19) United States
(12) Patent Application Publication
(10) Pub. No.: US 2025/0337926 A1
(43) Pub. Date: Oct. 30, 2025

(54) HIGH RESOLUTION AND LOW LATENCY VIDEO STREAMING USING PARTIAL FRAME SAMPLING

(71) Applicant: NVIDIA Corporation, Santa Clara, CA (US)

(72) Inventors: Fateh SABAH, Den Haag (NL); Viktor VANDANOV, San Jose, CA (US); Olivier LAPICQUE, Deerfield Beach, FL (US); Hassane Samir AZAR, Los Altos, CA (US); Mohamadreza MARANDIAN HAGH, San Jose, CA (US)

(73) Assignee: NVIDIA Corporation, Santa Clara, CA (US)

(21) Appl. No.: 18/646,978

(22) Filed: Apr. 26, 2024

(51) Int. Cl. H04N 19/172; H04N 19/132; H04N 19/136; H04N 19/167; H04N 19/423

(52) U.S. Cl. CPC H04N 19/172; H04N 19/132; H04N 19/136; H04N 19/167; H04N 19/423

(57) ABSTRACT

In various examples, systems and methods are disclosed relating to high resolution and low latency video streaming are disclosed. A system can capture, from data generated by an application, a plurality of partial frames according to a sampling rate. The system can generate a plurality of packet groups, where each group includes one or more packets storing a respective partial frame of the plurality of partial frames and respective location metadata for the partial frame. The system can transmit the plurality of packet groups to a receiver system accessing the application, where each group is transmitted at a respective time.

### BACKGROUND

Video streaming involves encoding and transmitting video data over a network to a remote client device, which subsequently decodes the video. Conventional approaches for video streaming involve transmitting the entirety of a video frame before transmitting the next frame in the video stream. This results in saturated and inefficient bandwidth utilization because the network experiences high peak bandwidth consumption during transmission of frames, but relatively lower bandwidth consumption between transmission of frames.

### SUMMARY

Embodiments of the present disclosure relate to techniques for providing high-resolution, low-latency video streaming in multimedia communication systems. The systems and methods described herein improve upon conventional video streaming technology by transmitting portions of frames at higher frame rates. Unlike conventional approaches that transmit the entirety of a video frame before beginning transmission of a subsequent frame, the techniques described herein capture and encode partial frames for transmission. By capturing and encoding only partial representations of a frame at a rate higher than the frame rate of the video stream, the systems and methods described herein can transmit lower amounts of data at a more consistent cadence, thereby reducing peak network bandwidth utilization without sacrificing video resolution or quality.

At least one aspect relates to one or more processors. In one or more embodiments, the one or more processors include one or more circuits. The one or more circuits are used to capture, from data generated by an application, a plurality of partial frames according to a sampling rate. The one or more circuits are used to generate, based on the plurality of partial frames, a plurality of packet groups (groups of packets). Each packet group can comprise one or more packets storing a respective partial frame of the plurality of partial frames and respective location metadata for the partial frame. One or more circuits can transmit the plurality of packet groups, each group at a respective time, to a receiver system accessing the application.

In some implementations, the one or more circuits are used to capture the plurality of partial frames at respective temporal positions. In some implementations, the one or more circuits are used to transmit each of the plurality of packet groups based at least on the sampling rate. In some implementations, the one or more circuits are used to capture the plurality of partial frames according to a sampling pattern. In some implementations, the one or more circuits are used to capture a first partial frame according to the sampling pattern and a first position. In some implementations, the one or more circuits are used to capture a second partial frame according to the sampling pattern and a second position different from the first position.

In some implementations, the one or more circuits are used to shift the sampling pattern to determine the second position. In some implementations, one or more (e.g., each) of the plurality of partial frames is captured for a video stream to be presented (e.g., rendered) at a certain refresh rate. In some implementations, the one or more circuits are used to determine the sampling rate based at least on the refresh rate at which the video stream is to be presented. In some implementations, the sampling rate is at least twice the refresh rate at which the video stream is to be presented. In some implementations, the one or more circuits are used to capture the plurality of partial frames according to a temporal zig zag pattern or a temporal Halton sequence. In some implementations, the location metadata comprises a rendering position for the partial frame.

At least one aspect relates to a system. The system can include one or more processors. The one or more processors can receive, from one or more servers, a plurality of packet groups corresponding to an application streamed from the one or more servers. Each packet group can include one or more packets storing a respective partial frame of the plurality of partial frames and respective location metadata for the partial frame. The one or more processors can generate a frame of a video stream using the respective location metadata for at least one of plurality of partial frames. The one or more processors can render the frame according to a frame rate of the application.

In some implementations, the one or more processors can generate the frame using an accumulator buffer. In some implementations, the one or more processors can clear the accumulator buffer responsive to rendering the frame. In some implementations, the one or more processors can update the frame responsive to receiving a packet comprising a partial frame. In some implementations, the one or more processors can perform temporal anti-aliasing (TAA) responsive to generating the frame.

At least one aspect is related to a method. The method can include capturing, from one or more servers, a plurality of partial frames according to a sampling rate. The method can include generating a plurality of packet groups. Each packet group comprising one or more packets storing a respective partial frame of the plurality of partial frames and respective location metadata for the partial frame. The method can include transmitting the plurality of packet groups, each group at a respective time, to a receiver system accessing the application.

In some implementations, the method includes capturing the plurality of partial frames at respective temporal positions. In some implementations, the method includes transmitting each of the plurality of packet groups based at least on the sampling rate.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations, a system implemented using one or more language models—such as a large language model (LLM) and/or a vision language model (VLM), a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for high-resolution and low latency video streaming are described in detail below with reference to the attached drawing figures, wherein:

FIG. 1 is a block diagram of an example system for high-resolution and low latency video streaming by capturing and encoding partial frames, in accordance with some embodiments of the present disclosure;

FIGS. 2A and 2B depict example diagrams showing how consecutive partial frames can be transmitted by the example system of FIG. 1, in accordance with some embodiments of the present disclosure;

FIG. 3 is a flow diagram of an example of a method for high-resolution and low latency video streaming by capturing and encoding partial frames, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

The present disclosure relates to systems and methods for high-resolution, low-latency video streaming in multimedia communication systems. Video streaming from a server to a client is performed by encoding sequences of frames at predetermined resolution(s) and transmitting said frames in order over a network according to a predetermined framerate. For example, a streaming server may transmit one or more packets that include data encoding entire frames of a video stream. These packets are then received by a streaming client, which parses the packets, decodes the frame(s), and renders the video stream for display according to the video stream's frame rate, refresh rate, and/or resolution. This process repeats for each frame that is transmitted by the streaming server.

Conventional approaches transmit the entirety of a video frame before transmitting the next frame in the video stream. At high resolutions, frame rates, and/or refresh rates, the network experiences high peak bandwidth consumption while continuously transmitting the video stream, which may quickly saturate available network bandwidth when streaming to multiple clients. These issues become particularly pronounced when the video stream is produced by a real-time or near real-time application, such as a video game application accessed via a game streaming service. Such real-time or near real-time applications prevent alternative approaches for reducing playback latency from being implemented, such as client-side pre-caching of frame data.

The systems and methods of the present disclosure provide techniques for high resolution and low latency streaming by capturing and encoding partial frames for transmission, rather than encoding and transmitting entire video frames produced by an application. By capturing and encoding only partial representations of a frame at a high rate, the systems and methods described herein can transmit lower amounts of data at a more consistent cadence, thereby reducing peak network bandwidth utilization without sacrificing video resolution or quality.

To do so, the systems and methods described herein can use a sampling pattern to spatially select pixels to capture for a frame from a given temporal position. This sampling can be performed at a high rate, such that the partial frame representations cannot be detected by the human eye. The sampling rate for partial representations of a frame may be an integer multiple of the frame rate for the video stream. For example, if the video stream frame rate is sixty (60) frames-per-second, the selected sampling rate for capturing partial representations of frames can be two-hundred forty (240) frames-per-second. In some implementations, the sampling rate for partial representations of a frame may be an integer multiple of a refresh rate (e.g., 240 Hz) at which the video stream is to be presented. The refresh rate may be identified from metadata of a display that is to present the video stream.

Capturing the partial representations can be performed according to any suitable sampling pattern. In one example, quadrants of frames may be captured at a selected sampling rate that is four times the frame rate or refresh rate of the video stream. Each partial representation may be captured as a direct partial representation, such that each partial representation is captured from a separate temporal position at the selected sampling rate. Other sampling patterns, such as a Halton sequence, may also be used. The generated partial frames can then be encoded and transmitted via a suitable streaming protocol to a client device.

Upon receiving the encoded partial frames, the client device can integrate the partial representations to produce a full, rendered image at the intended frame rate and/or refresh rate of the video stream. For example, each time a partial frame is decoded, its pixels can be mapped to their original position in a rendering buffer, according to additional metadata included with the encoded partial frames during transmission. In some implementations, temporal antialiasing can be implemented to reduce the appearance of jagged edges or artifacts in constructed frames. Partial representations of frames can be rendered as they are received, without necessarily clearing the rendering buffer.

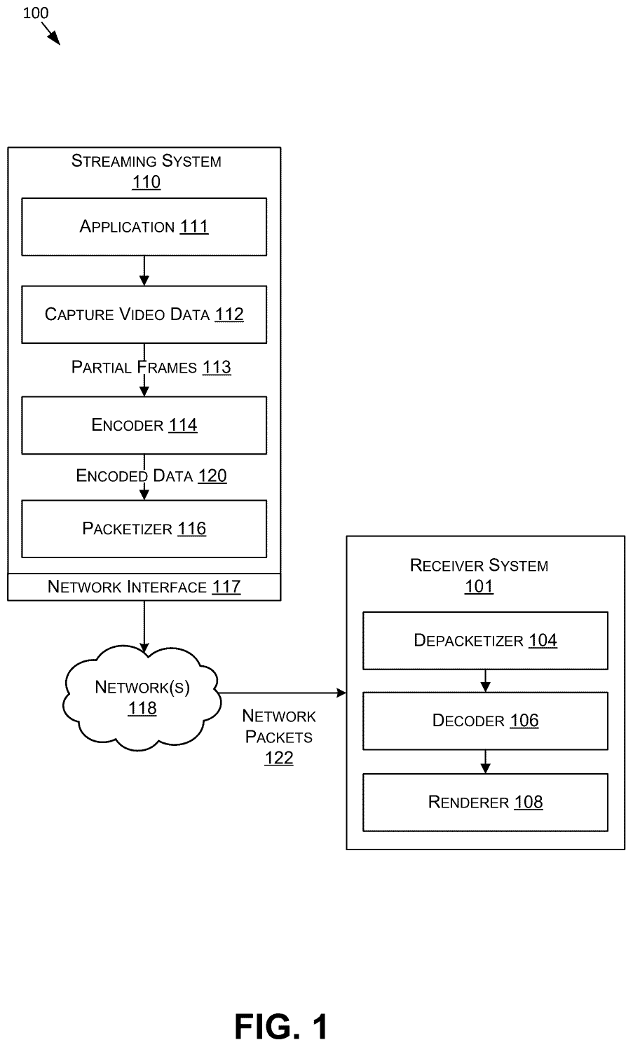

With reference to FIG. 1, FIG. 1 is an example computing environment including a system for high-resolution and low latency video streaming by capturing and encoding partial frames, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including the streaming system 110. The streaming system 110 can provide (e.g., stream) video data of an application 111 via the network 118 to a receiver system 101. The application 111 can be any type of network-accessible application from which frames of video data can be captured. For example, the application 111 can include a video playback process, a gaming process (e.g., video output from remotely executing video games), a remote-desktop environment, a video communication platform, among other sources of video data.

In some implementations, the application 111 may be a remotely executed gaming application. In a remote gaming configuration, the streaming system 110 may execute one or more game applications and may receive input data transmitted from the receiver system via the network 118 to control the application 111. In some implementations, the application 111 may not necessarily execute on the streaming system 110 and may be executed via one or more external servers or computing systems. In such implementations, the streaming system 110 can receive video data produced by the application 111 from the one or more external servers or computing systems to perform the techniques described herein.

As noted, conventional approaches for video streaming result in high peak bandwidth consumption at higher resolutions, frame rates, and refresh rates. This can saturate available network bandwidth when streaming to multiple clients, which is a significant drawback when streaming applications 111. To address these issues, the streaming system 110 can execute a capture process 112 to capture partial frames 113 from video data produced by the application 111. While in conventional systems entire frames are generated from video data and subsequently transmitted, the capture process 112 can capture spatial and temporal partial frames 113, which have reduced resolution relative to the actual resolution of the video stream. Partial frames 113 can be captured at a higher rate than that of the video stream. For example, instead of sampling entire 4K frames (e.g., 2160p) at sixty frames-per-second, partial frames 113 capturing different spatial pixels at a resolution of 1080p from different temporal frames at a rate of 240 frames per second.

Furthering this example, as four frames of 1080p resolution fit within a 4K frame, and because the sample rate is four times the actual frame rate or refresh rate of the video stream, sampling partial frames 113 at an increased sampling rate enables transmission/streaming of the same amount of video data as an entire single frame. However, because the partial frames 113 include less information than an entire frame and transmitted at a greater frequency than the frame rate or refresh rate of the video stream, peak network bandwidth utilization is reduced. This improvement enables higher quality video streams to be transmitted to greater numbers of receiver systems 101 without saturating peak network bandwidth.

The capture process 112 can sample video data produced by the application according to a sampling rate and a sampling pattern. The sampling rate can be a rate (e.g., a number of times a second) at which partial frames 113 are captured from the video data produced by the application 111. The sampling pattern is the pattern that defines spatial portions of the video data that are captured across temporal frames. Various attributes implemented by the capturing process 112 can be specified via various configuration settings, including the resolution, sampling rate, and sampling pattern used to generate the partial frames 113. For example, in some implementations, the streaming system 110 can store one or more configuration settings for the capture process 112. In some implementations, one or more of the configuration settings for the capturing process 112 can be specified by the receiver system 101 (e.g., in a request to access video streaming capabilities of the application 111).

Although shown as a separate process, in some implementations the capture process 112 can be implemented by the application 111 provided by the streaming system 110. In other implementations, the capture process 112 can be different from the application 111 and can receive or otherwise access video data produced by the application 111. For example, the application 111 can generate data from which pixel data for a video frame (or a partial frame 113) can be captured. Said video data can be updated over time, such that different partial frames 113 can be captured at different types to depict different spatial and temporal portions of the video data.

Any suitable sampling pattern can be utilized by the capturing process 112 to generate partial frames 113. One example of a sampling pattern is a zig zag pattern. In an example zig-zag sampling pattern, four partial frames 113 can be captured at a rate that is four times greater than the frame rate or refresh rate of the video stream. Furthering this example, the resolution of said partial frames 113 can be half that of the video stream, such that four partial frames 113 can be assembled to generate a single entire frame of the video stream.

When sampling a partial frame 113 for a given temporal position (e.g., a time period between full frames of the video stream), the capture process can spatially select pixels from video data of the application to capture. Any set of pixels, in any configuration, can be selected for the partial frame 113. In some implementations, pixels for partial frames 113 can be selected according to geometric patterns. For example, pixels making up rectangular portions of video data from the application 111 can be selected for inclusion in a partial frame. The pattern of pixels selected for inclusion in a partial frame 113 can be spatially shifted along x-y coordinates, such that each partial frame 113 represents a different spatial portion of the video data produced by the application 111.

The amount by which the sampling pattern is shifted between frames can be determined based at least on the type sampling pattern that is used to generate the partial frames 113. For example, in an example where rectangular partial frames 113 are selected, the sampling pattern can be shifted by one dimension of the rectangle (e.g., the width of the rectangle if shifted left or right, the height of the rectangle if shifted up or down). The amount by which the sampling pattern shifts can be a function of the sampling rate, the frame rate, and/or the refresh rate of the video stream. For example, in some implementations the sampling pattern can shift such that partial frames 113 representing an entire, full frame of the video stream are captured in accordance with the frame rate or refresh rate of the video stream. The capturing process 112 can shift the sampling pattern in a cycle, such that once all pixels representing a full frame of the video stream has been captured, the sampling pattern can be shifted back to its original position. In some implementations, the sampling pattern can shift such that partial frames 113 representing less than an entire frame of the video stream are captured in accordance with the frame rate or refresh rate of the video stream.

Any suitable sampling pattern can be used to capture the partial frames 113. One example is a zig-zag pattern, in which rows of partial frame rectangles are sampled across the full resolution of the video stream, and shifted down and back to the beginning of each row once a row has been completed. Another example sampling pattern is a Halton sequence. Each partial frame 113 can be stored in association with respective metadata that indicates the region of the video data that represented by the partial frame 113. This location metadata can be used at the receiver system 101 to render the video data of the application 111, as described herein, by indicating a position within the video frame at which the partial frame 113 is to be rendered.

Each partial frame 113 can be sampled according to a sampling rate. The sampling rate can be selected such that it is greater than the frame rate or refresh rate of the video stream. In some implementations, the sampling rate can be an integer multiple of the frame rate or refresh rate of the video stream. For example, the sample rate may be four times the frame rate or refresh rate of the video stream (e.g., a sampling rate of 240 frames per second if the video frame rate is 60 frames per second, etc.). The sampling rate, relative to the video frame rate/or video refresh rate, can specify the number of partial frames 113 that can be captured from the video data in a single sampling cycle (e.g., such that each portion of video data representing a frame is captured). The sampling rate can be specified in one or more configuration settings maintained by the streaming system 110. The sampling rate can be selected such that rendering partial frames 113 at the receiver system 101 cannot be tracked by the human eye. In some implementations, the streaming system 110 can determine the sampling rate based at least on the frame rate of the video stream. For example, the streaming system 110 may determine the sampling rate as twice the frame rate of the video stream, three times the frame rate of the video stream, four times the frame rate of the video stream, etc. In some implementations, the sampling rate for partial representations of a frame may be an integer multiple of a refresh rate at which the video stream is to be presented/rendered. The refresh rate may be identified from metadata of a display that is to present/render the video stream.

The partial frames 113 described herein can be sampled directly from data produced from the application 111, rather than being sampled from full, rendered frames of the video stream, which allowed for improved performance and enables increased sampling rate and temporal quality. Each partial frame 113 can be captured from data corresponding to a unique temporal frame, captured at the sampling rate. In some implementations, each partial frame 113 can be stored in association with an identifier of the temporal frame to which the partial frame 113 corresponds.

In some implementations, the streaming system 110 can dynamically modify the sampling rate and/or the sampling pattern in response to messages from the receiver system 101 and/or one or more external computing systems. In one example, the streaming system 110 may decrease the sample rate while increasing the size of the sampling pattern (and reducing the number of partial frames 113 generated per sampling cycle). In another example, the streaming system 110 can increase the sampling rate while decreasing the size of the sampling pattern (and increasing the number of partial frames 113 generated per sampling cycle). In some implementations, the streaming system 110 can dynamically modify the sampling rate and/or the sampling pattern to balance utilization of the network 118, for example, to reduce peak network bandwidth and/or respond to changing network utilization conditions.

Once captured, the partial frames 113 and any associated metadata (e.g., location/temporal metadata) can be provided as input to the encoder 114. The encoder 114 of the streaming system 110 can encode the video data of the partial frames 113 into a suitable format, for example, according to a predetermined codec or bitstream format. Encoding streaming video data reduces the overall amount of information that is to be transmitted to via the network 118 to the receiver system 101. The encoder 114 may utilize any combination of hardware or software to encode the partial frames 113.

Encoding the partial frames 113 can include converting the video data of the partial frames 113 to conform to any suitable codec, including but not limited to an H.264 codec, an H.265 codec, an AVI codec, a VP8 codec, a VP9 codec, or any other video codec that supports segmentation of a video frame into distinct geometric regions. Encoding the partial frames 113 may include segmenting one or more portions of the partial frames 113 into one or more regions, such as slices or tiles. In some implementations, each partial frame 113 can be encoded as a single slice, tile, or region of the video frame of the video stream.

The encoder 114 can encode the partial frames 113 according to the location-based metadata for the frame. Each encoded portion of a partial frame 113 can correspond to a respective geometric region of the partial frames 113. In some implementations, the partial frames 113 can be encoded such that the encoded data represents one or more geometric regions of a full video stream, mapped to a corresponding location in the video frame using the location metadata of the partial frame 113. In some implementations, encoding the partial frames 113 can include generating one or more macroblocks for the video stream. In some implementations, the number of reference frames used for encoding the partial frames 113 can be greater than or equal to the number of partial frames 113 generated in a sampling cycle (e.g., a number of partial frames 113 generated to construct a single, entire video frame at the resolution of the video stream).

The encoder 114 can perform various compression techniques in encoding video data for a video stream. For example, the encoder 114 may perform intra-frame compression techniques, inter-frame compression techniques, and rate control compression techniques, including but not limited to motion estimation, quantization, and entropy coding. The encoded partial frames 113 produced by the encoder 114 can be provided as the encoded data 120. The encoded data 120, as shown, can be provided to the packetizer 116 to generate one or more network packets 122 for transmission to the receiver system 101 via the network 118.

The encoded data 120 includes one or more encoded partial frames 113 captured using the capture process and generated using the encoder 114. Portions of the encoded data 120 can be stored in association with, or otherwise include metadata a location at which the corresponding partial frame 113 is to be rendered at the receiver system 101. In some implementations, the encoded data 120 may include audio data, which may be generated by the encoder 114 using a suitable audio encoding process. In some implementations, audio data may be formatted as a separate bitstream.

The encoder 114 can generate and provide the encoded data 120 to the packetizer 116 for transmission to the receiver system 101 via the network 118. The encoder 114 can generate encoded data 120 for each partial frame 113 captured using the capturing process 112. Once the encoded data 120 for a partial frame 113 has been generated, the packetizer 116 can transmit the encoded partial frame 113 (e.g., the encoded data 120) to the receiver system 101. As such, partial frames 113 can be transmitted to the receiver system 101 prior to or concurrent with generation of subsequent partial frames 113. Doing so reduces overall peak network bandwidth utilization and reduces overall latency, as described herein.

To do so, the packetizer 116 can divide the encoded data 120 into one or more network packets 122 (e.g., a group of network packets 122). In some implementations, each group includes at least a respective portion of an encoded partial frame 113 (e.g., a portion of the encoded data 120). For example, in some implementations, a single network packet 122 may be insufficient to carry data for an entire encoded partial frame 113. In such circumstances, the packetizer 116 can generate multiple packets to carry data for an encoded partial frame 113 (e.g., as stored in the encoded data 120). The group of network packets 122 can then be transmitted to the receiver system 101, which can reconstruct each partial frame 113 as described in further detail herein.

The packetizer 116 can use any suitable video streaming protocol or network packet protocol to transmit the encoded data 120. For example, the packetizer 116 may utilize the real-time transport protocol (RTP) and/or the user datagram protocol (UDP) to generate the network packets 122. In some implementations, a group of one or more network packets 122 can be generated to include both encoded data 120 for a partial frame 113 and any corresponding location metadata for the partial frame 113. Each grouping of network packets 122 can provide a mapping between the partial frame 113 represented by the encoded data 120 and a corresponding location in the video stream at which the partial frame 113 is to be rendered.

The packetizer 116 can generate the network packets 122 to accommodate various characteristics of the network. For example, the packetizer 116 may generate the network packets 122 to include video streaming protocol data that satisfies the size of the maximum transmission unit (MTU) of the network 118, which is the maximum size of a packet that can be transmitted over the network without being fragmented. To do so, the packetizer 116 may, in some implementations, split regions (e.g., slices, tiles, contiguous sequence(s) of macroblocks, any other logical sub-unit of a partial frame 113, etc.) into multiple network packets 122 to satisfy the MTU.

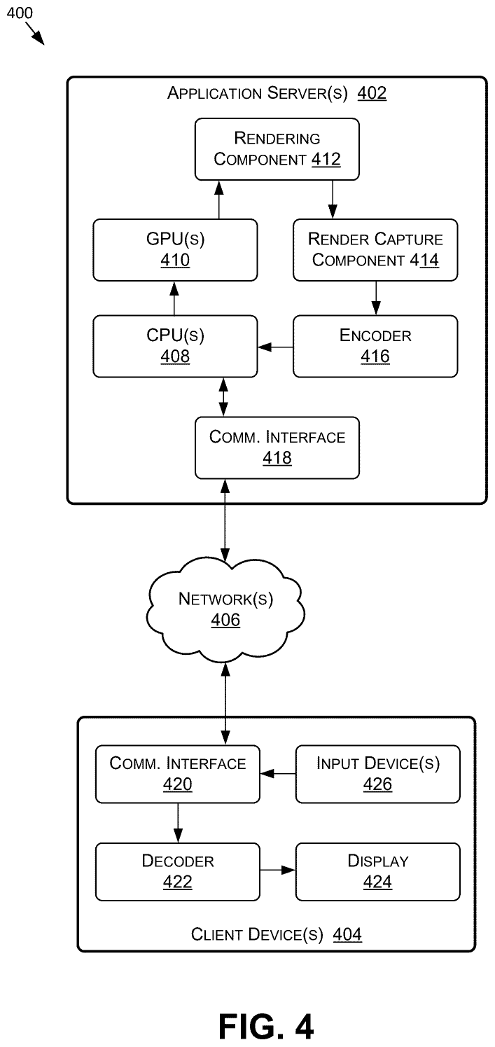

Each of the network packets 122 may be transport protocol packets, such as transport control protocol (TCP) and UDP packets. The network packets 122 can be transmitted via the network interface 117 of the streaming system 110. The network interface 117 of the streaming system 110 may include any of the structure of, and implement any of the functionality of, the communication interface 418 described in connection with FIG. 4.

The receiver system 101 may be any computing system suitable to receive and process network packets 122 as described herein. The receiver system 101 can receive the network packets 122. In some implementations, the receiver system 101 may include or may be in communication with a display device that can present decoded video data generated based at least on the network packets 122. For example, the receiver system 101 can present decoded video data produced by the application 111 accessed via the streaming system 110. The receiver system 101 may implement error concealment techniques to reduce visual artifacts in the transmitted video information, such as TAA or other types of antialiasing techniques.

The depacketizer 104 of the receiver system 101 can receive the network packets 122 transmitted from the streaming system 110 and assemble one or more decodable units of video data to provide to the decoder 106. As described herein, the network packets 122 may be generated and transmitted to store encoded data 120 for at least one partial frame 113. If the size of the encoded data 120 for a partial frame 113 exceeds the maximum payload size for the network, a group of network packets 122 storing encoded data 120 for a partial frame are generated and transmitted by the streaming system 110. The depacketizer 104 can receive the encoded data 120 corresponding to a partial frame 113 from a group of one or more network packets 122 and provide the encoded data 120 to the decoder 106 for processing. The depacketizer 104 can provide any metadata, such as location metadata indicating the location in the video frame at which the partial frame 113 is to be rendered, to the decoder 106.

The decoder 106 can receive, parse, and decode the encoded bitstream assembled by the depacketizer 104. To do so, the decoder 106 can parse the encoded data 120 to extract any associated video metadata, such as the frame size, frame rate, and audio sample rate for the video stream for which the partial frame 113 was generated. In some implementations, the decoder 106 can identify the codec based at least on the metadata and decode the encoded bitstream using the identified codec to generate data video and/or audio data. In some implementations, such video metadata may be transmitted in one or more packets that are separate from the network packets 122 that include video data. This may include decompressing or performing the inverse of any encoding operations used to generate the encoded data 120 at the streaming system 110. The decoder 106, upon generating the decoded video data for a partial frame 113, can provide the decoded video frame data to the renderer 108 for rendering.

The renderer 108 can render and display the decoded partial frame data received from the decoder 106. In some implementations, the renderer 108 can maintain an accumulator buffer that stores the most up-to-date frame data for the video stream received from the streaming system 110. The accumulator buffer can be a data structure that maintains up-to-date pixel data for the current frame of the video stream. The size of the accumulator buffer can correspond to the actual resolution of the video stream. For example, if the video stream is a 4K video stream, the accumulator buffer can store pixels for 3840×2160 video data. As partial frames 113 do not include enough information to update the entirety of the buffer, renderer 108 can update portions of the accumulator buffer with a partial frame 113 based at least on the location metadata associated with the partial frame 113. In some implementations, the size of the accumulator buffer can be larger than the resolution of the video stream. For example, in some implementations, the partial frames 113 may include data representing non-integer pixel positions in the full original frame. In such implementations, the rendering process may scale the accumulator buffer to properly render the pixel data to a physical display device.

For example, the renderer 108 can access the location metadata of the partial frame 113, which indicates the location (and in some implementations, size or geometric configuration) of the video frame to which the pixels of the partial frame 113 are to be mapped. Once identified, the renderer 108 can update the video frame data in the accumulator buffer data structure such that the pixels of the partial frame 113 replace the existing pixels in the accumulator buffer at the locations indicated in the location metadata. In some implementations, the renderer 108 can maintain and not modify the other pixels in the accumulator buffer. As such, each time a partial frame 113 is received and decoded by the receiver system 101, the renderer 108 can update the portion of the accumulator buffer such that the video data includes data from previously received partial frames 113 and the currently received partial frame 113.

In some implementations, the renderer 108 can render the video data in the accumulator buffer in response to updating the accumulator buffer. In some implementations, the renderer 108 can render the video data in the accumulator buffer each time partial frame 113 data is written to the accumulator buffer (e.g., as each partial frame 113 is received, roughly according to the sampling rate of the application 111). In some implementations, the renderer 108 can render the video data in the accumulator buffer each time a full video frame has been assembled in the accumulator buffer (e.g., from a corresponding set of partial frames 113), for example, according to the frame rate of the video stream. In some implementations, the renderer 108 can render the video data in the accumulator buffer according to a refresh rate of the display device at which the video stream is to be presented. In some implementations, the renderer 108 can purge or clear the accumulator buffer each time a partial frame 113 is written to the accumulator buffer, or in some implementations, each time a full frame is written to the accumulator buffer.

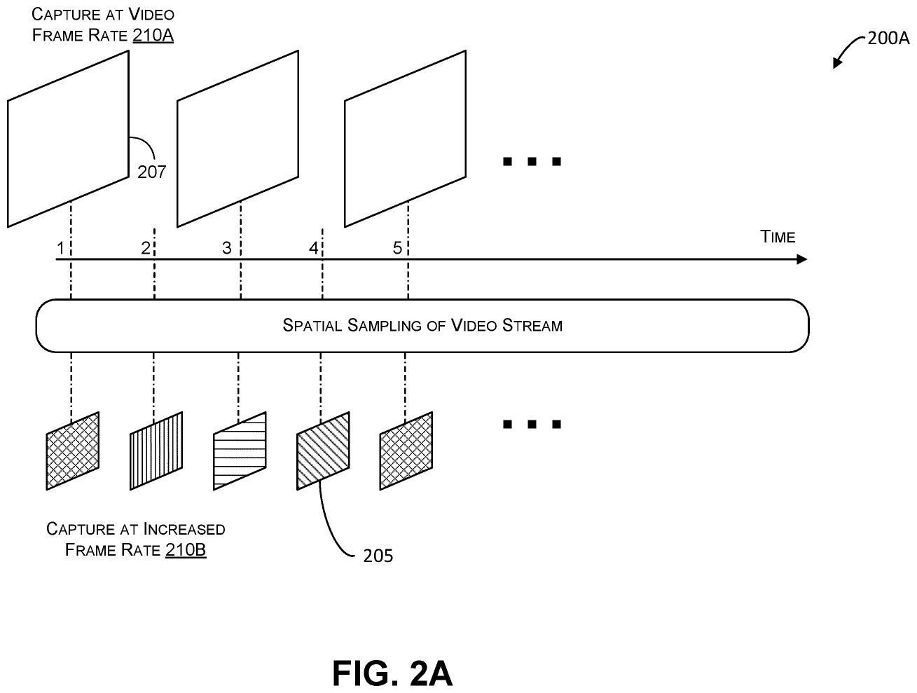

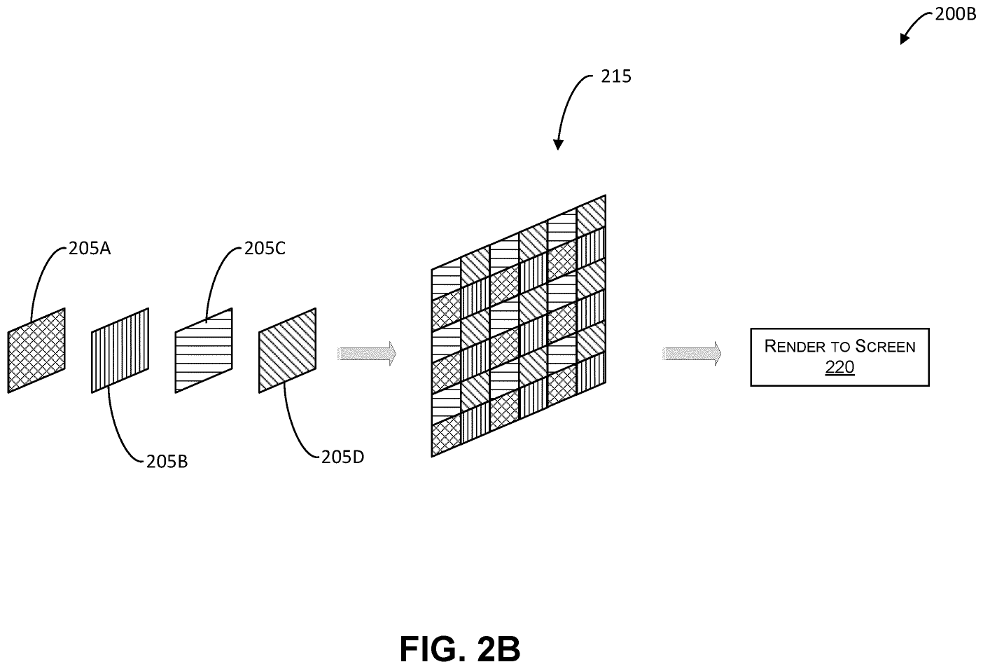

The renderer 108 can render the decoded video data and display it on any suitable display device, such as a monitor, a television, or any other type of device capable of displaying decoded video data. In some implementations, the accumulator buffer is a frame buffer. In some implementations, the renderer 108 can copy the decoded video data from the accumulator buffer into a separate frame buffer. The renderer 108 can scan out the frame buffer contents (e.g., either the accumulator buffer or a separate frame buffer) to the display device. Example representations of providing partial frames 113 according to a sampling rate and storing partial frames 113 in an accumulator buffer are described in connection with FIGS. 2A and 2B.

Referring to FIGS. 2A and 2B, illustrated are example diagrams 200A and 200B showing how consecutive partial frames can be transmitted by the example system of FIG. 1, in accordance with some embodiments of the present disclosure. FIG. 2A shows an example representation comparing a transmission scheme in which entire video frames 207 are transmitted and a transmission scheme in which partial frames 205 are transmitted. As described herein, transmission of entire video frames 207 results in high peak bandwidth consumption, because large amounts of data are transmitted at a single time when transmitting an entire, single frame. This is because each frame must be generated and transmitted before the next frame in the video stream can be generated and transmitted. As such, each full frame 207 is transmitted in its entirety prior as soon as it is generated. For video streams with high resolution, or circumstances where video streaming is performed to a large number of receiver systems (e.g., the receiver systems 101), large amounts of data must be transmitted at a single period of time (e.g., according to the frame rate 210A of the video stream).

To address these shortcomings, the present techniques enable transmission of spatial and temporal partial frames 205 (e.g., similar to the partial frames 113) at an increased frame rate 210B, which is greater than the frame rate 210A of the video stream. As less information is transmitted at a given time (e.g., each time a partial frame 205 is generated), peak network bandwidth utilization is reduced without sacrificing video stream quality. As shown, in this example, during the period that entire frames 207 would be transmitted, two separate partial frames 205, each including pixel data of a fourth of the entire frame 207, are generated and transmitted.

As described herein, the partial frames 205 can be selected according to a sampling pattern that is spatially shifted across sequential temporal frames (captured at the increased sampling rate 210B). In the example shown in FIG. 2A, the pattern indicated on each partial frame 205 represents a spatial sampling position of the partial frame 205. As shown, the spatial sampling position cycles according to a predetermined pattern, which repeats every four partial frames 205. Each partial frame 205 can include pixel data captured at the increased frame rate, such that a first partial frame 205 includes temporally different information than a subsequent partial frame 205. Examples showing how the partial frames 205 are rendered at a receiver system 101 are shown in FIG. 2B.

Referring to FIG. 2B, illustrated is an example diagram 200B showing how partial frames 205 (shown here as four sequential partial frames 205A, 205B, and 205C) used to update an accumulator buffer 215. As shown, four sequential partial frames 205A, 205B, and 205C are received at a receiver system (e.g., the receiver system 101) and used to update an accumulator buffer. The accumulator buffer is updated each time a partial frame 205 is received. Pixel data included in each partial frame 205 is mapped to a corresponding pixel location at the accumulator buffer 215 according to the sampling pattern used to capture the partial frames 205. The partial frames 205 may include pixel data for any number of arrangement of pixels of what is ultimately rendered in the rendering process 220. In this example, the pixel data of the partial frames 205 are mapped to corresponding locations in the accumulator buffer according to a temporal zig zag pattern.

For example, each partial frame may not necessarily be a continuous region of data and may include patterns of pixels that span any dimension of the actual resolution of the video stream. Likewise, although only four partial frames 205 are shown as being assembled into a single frame in the accumulator buffer 215, it should be understood that any number of partial frames may be generated according to a sampling rate that is greater than the frame rate of the video stream, as described herein. The rendering process 220 can be executed each time the accumulator buffer 215 is updated with pixel data from a partial frame 205, in some implementations. Updating the accumulator buffer 215 can include replacing pixel data in the accumulator buffer 215 with updated pixel data from a received partial frame 205. The rendering process 220 can include drawing the updated accumulator buffer 215 to a display, as described herein.

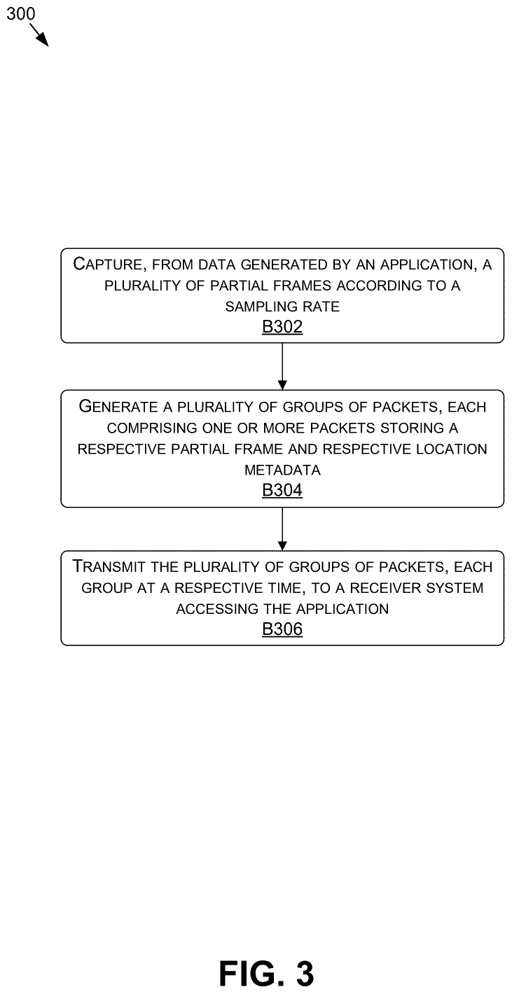

Now referring to FIG. 3, each block of method 300, described herein, includes a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for high-resolution and low latency video streaming by capturing and encoding partial frames, in accordance with some embodiments of the present disclosure. The method 300, at block B302, includes capturing, from data generated by an application (e.g., an application 111), one or more partial frames (e.g., partial frames 113) according to a sampling rate. The application can be provided via one or more servers (e.g., a streaming system 110) as part of a video streaming process. The data generated by the application may include video data, or data from which video data can be generated. The partial frames may have a resolution that is less than a resolution of a video stream. The sampling rate may be specified via one or more configuration settings. The sampling rate can be greater than the frame rate of the video stream. In some implementations, the sampling rate can be determined based at least on the frame rate of the video stream. For example, the sampling rate may be a multiple of the frame rate of the video.

Each of the partial frames can be captured according to a sampling pattern. The sampling pattern can be any pattern of pixels to be extracted from the data produced by the application. The pixel pattern can be any arrangement or geometric configuration of pixels, in some implementations. The partial frame can, in some implementations, include a predetermined number of pixels that is a fraction of the total number of pixels in a complete frame of the video stream. Partial frames can be captured from the data by spatially shifting the sampling pattern according to a shifting pattern. In some implementations, the sampling pattern can be shifted to capture partial frames at different rendering positions. The sampling pattern can be shifted according to a zig zag pattern or a Halton sequence, or any other shifting pattern/sequence. Each partial frame can be associated with location metadata that indicates a rendering position for the partial frame. The location metadata can be generated according to the position of the sampling pattern when the partial frame is captured. Partial frames can be captured at different temporal positions, such that each partial frame is captured from data corresponding to a unique temporal frame.

The method 300, at block B304, includes generating a plurality of packet groups. Each group can include one or more packets (e.g., network packets 122) storing a respective partial frame of the partial frames and the respective location metadata for the partial frame. Once a partial frame is generated, the pixel data included in the partial frame can be encoded to generate bitstream data (e.g., the encoded data 120) for the partial frame. The partial frames can be encoded according to any suitable codec or encoding process. Network packets are generated to transmit the encoded data to a receiver system.

In some implementations, the size of the encoded data of a partial frame can exceed a maximum payload size of a network packet. In such circumstances, the encoded data can be split into portions that are each included in a respective network packet. In some implementations, network packets can be generated according to the sampling rate (e.g., as partial frame is captured). The network packets can be generated according to any suitable protocol, including RTP, UDP, or TCP, among others.

The method 300, at block B306, includes transmitting the plurality of packet groups. Each group can be transmitted at a respective time to a receiver system accessing the application. For example, each group of packets can store a partial frame generated from data produced via the application. The group encoding a partial frame can be transmitted to the receiver system according to the sampling rate, in some implementations. Each group of network packets can store the location metadata that indicates a rendering position of the partial frame stored therein. Once transmitted, the receiver system can receive the network packets and decode the partial frames stored therein. The receiver system can update an accumulator buffer with the partial frame pixel data and can render the pixel data in the accumulator buffer according to the sampling rate.

### Example Content Streaming System

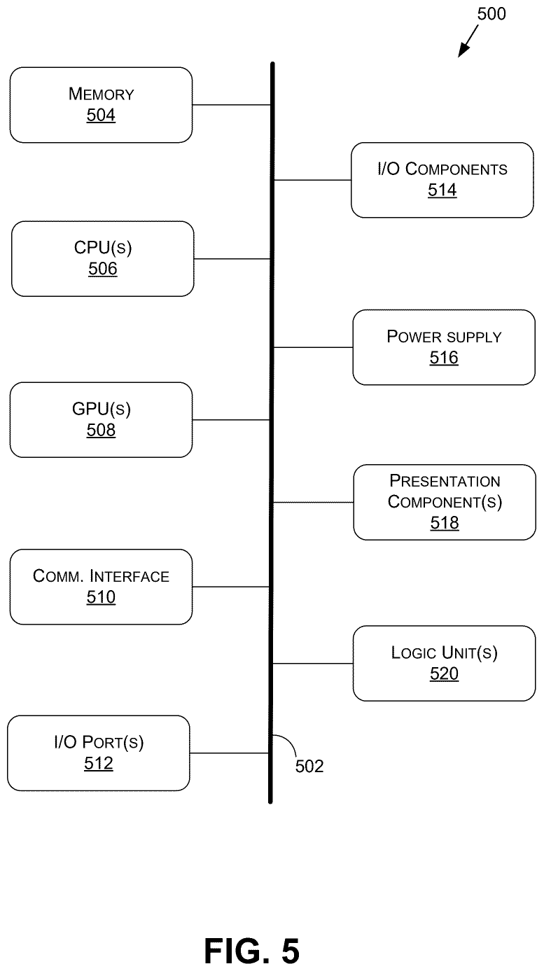

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 100 may be implemented by one or more components of the system 400 shown in FIG. 4. The application session may correspond to a game streaming application (e.g., NVIDIA Geforce NOW), a remote desktop application, a simulation application (e.g., autonomous or semi-autonomous vehicle simulation), computer aided design (CAD) applications, virtual reality (VR) and/or augmented reality (AR) streaming applications, generative AI applications, deep learning applications, and/or other application types.

In the system 400, for an application session, the client device(s) 404 may only receive input data in response to inputs to the input device(s) 426, transmit the input data to the application server(s) 402, receive encoded display data from the application server(s) 402, and display the display data on the display 424. As such, the more computationally intense computing and processing is offloaded to the application server(s) 402 (e.g., rendering—in particular, ray or path-tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based at least on receiving the display data from the application server(s) 402. The application server(s) 402 may implement any of the functionality of the streaming system 110 described in connection with FIG. 1. The client device 404 may receive an input to one of the input device(s) 426 and generate input data in response. The client device 404 may transmit the input data to the application server(s) 402 via the communication interface 420 and over the network(s) 406 (e.g., the Internet), and the application server(s) 402 may receive the input data via the communication interface 418. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data), and the render capture component 414 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424. The client device 404 may implement any of the functionality of the receiver system 101 described in connection with FIG. 1.

The systems and methods described herein may be used for a variety of purposes, by way of example and without limitation, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing, and/or any other suitable applications.

Disclosed embodiments may be used in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations implementing one or more large language models, systems for performing light transport simulation, systems for performing collaborative content creation for 3D assets, systems implemented at least partially using cloud computing resources, and/or other types of systems.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may include one or more virtual machines (VMs), and/or any of the components thereof may include virtual components (e.g., virtual hardware components). For non-limiting examples, one or more of the GPUs 508 may include one or more vGPUs, one or more of the CPUs 506 may include one or more vCPUs, and/or one or more of the logic units 520 may include one or more virtual logic units. As such, a computing device 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may include computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not include signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be implemented/configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be implemented/configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506) and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLink) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be implemented/configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., to a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. A NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.) and output the data (e.g., as an image, video, sound, etc.).

### Example Data Center

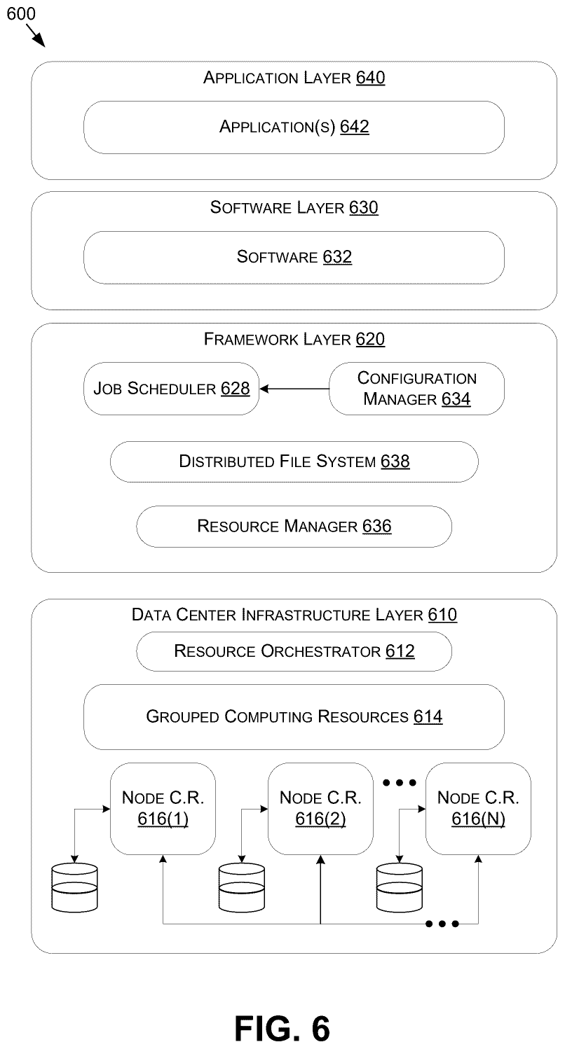

FIG. 6 illustrates an example data center 600 that may be used in at least one embodiment of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory, or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resources 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based at least on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or a combination thereof. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, the functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
capture, from data generated by an application, a plurality of partial frames according to a sampling rate;
generate, based on the plurality of partial frames, a plurality of packet groups, each packet group comprising one or more packets storing a respective partial frame of the plurality of partial frames and respective location metadata for the partial frame;
transmit the plurality of packet groups to a receiver system accessing the application.

2. The one or more processors of claim 1, wherein the one or more circuits are to capture the plurality of partial frames at respective temporal positions.

3. The one or more processors of claim 1, wherein the one or more circuits are to transmit each of the plurality of packet groups based at least on the sampling rate.

4. The one or more processors of claim 1, wherein the one or more circuits are to capture the plurality of partial frames according to a sampling pattern.

5. The one or more processors of claim 4, wherein the one or more circuits are to:
capture a first partial frame according to the sampling pattern and a first position; and
capture a second partial frame according to the sampling pattern and a second position that is different from the first position.

6. The one or more processors of claim 5, wherein the one or more circuits are to shift the sampling pattern to determine the second position.

7. The one or more processors of claim 1, wherein the plurality of partial frames are captured for a video stream to be presented at a refresh rate, and wherein the one or more circuits are to determine the sampling rate based at least on the refresh rate at which the video stream is to be presented.

8. The one or more processors of claim 7, wherein the sampling rate is at least twice the refresh rate at which the video stream is to be presented.

9. The one or more processors of claim 1, wherein the one or more circuits are to capture the plurality of partial frames according to at least one of a temporal zig zag pattern or a temporal Halton sequence.

10. The one or more processors of claim 1, wherein the location metadata comprises a rendering position for the partial frame.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations;
a system implemented using a large language model (LLM);
a system implemented using a vision language model (VLM);
a system for generating synthetic data;
a system incorporating one or more virtual machines (VMs);
a system implemented at least partially in a data center; or
a system implemented at least partially using cloud computing resources.

12. A system comprising:
one or more processors to:
receive, from one or more servers, a plurality of packet groups corresponding to an application streamed from the one or more servers, each packet group comprising one or more packets storing a respective partial frame of a plurality of partial frames and respective location metadata for the partial frame;
generate a frame of a video stream using the respective location metadata for at least one of plurality of partial frames; and
render the frame according to a frame rate of the application.

13. The system of claim 12, wherein the one or more processors are to generate the frame using an accumulator buffer.

14. The system of claim 13, wherein the one or more processors are to clear the accumulator buffer responsive to rendering the frame.

15. The system of claim 12, wherein the one or more processors are to update the frame responsive to receiving a packet comprising a partial frame.

16. The system of claim 12, wherein the one or more processors are to perform temporal anti-aliasing (TAA) responsive to generating the frame.

17. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations;
a system implemented using a large language model (LLM);
a system implemented using a vision language model (VLM);
a system for generating synthetic data;
a system incorporating one or more virtual machines (VMs);
a system implemented at least partially in a data center; or
a system implemented at least partially using cloud computing resources.

18. A method, comprising:
capturing, from data generated by an application, a plurality of partial frames according to a sampling rate;
generating a plurality packet groups, each packet group comprising one or more packets storing a respective partial frame of the plurality of partial frames and respective location metadata for the partial frame; and
transmitting the plurality of packet to a receiver system accessing the application.

19. The method of claim 18, further comprising:
capturing the plurality of partial frames at respective temporal positions.

20. The method of claim 18, further comprising:
transmitting each of the plurality of packet groups based at least on the sampling rate.
